(19) United States
(12) Patent Application Publication
(10) Pub. No.: US 2018/0354772 A1
(43) Pub. Date: Dec. 13, 2018

(54) ULTRA HIGH RATIO LIQUID DELIVERY SYSTEM

(71) Applicant: GLOBAL AGRICULTURAL TECHNOLOGY AND ENGINEERING, LLC., Vero Beach, FL (US)

(72) Inventors: Michael E. Cheney, Vero Beach, MA (US); Scott Ross, Sebastian, FL (US); John R. Newton, Vero Beach, FL (US)

(73) Assignee: GLOBAL AGRICULTURAL TECHNOLOGY AND ENGINEERING, LLC., Vero Beach, FL (US)

(21) Appl. No.: 15/571,690

(22) PCT Filed: May 5, 2016
(86) PCT No.: PCT/US16/30950

§ 371 Date: Nov. 3, 2017

Related U.S. Application Data
(60) Provisional application No. 62/157,569, filed on May 6, 2015.

(51) Int. Cl. B67D 1/00; B01F 3/08; B01F 5/04; B01F 15/02

(52) U.S. Cl. CPC B67D 1/0051; B67D 1/0021; B67D 1/004; B67D 7/74; B01F 5/0486; B01F 15/0238; B01F 15/0224; B01F 3/0865

(57) ABSTRACT

A liquid dispensing system comprises a container enclosing a chamber. A flexible bag in the chamber contains a first liquid. First and second conduits are contained in the chamber. The first conduit connects the chamber to an outlet port in the container were the second conduit connects the bag to the first conduit. A supply source introduces a pressurized second liquid into the chamber. The first conduit serves to direct an exiting flow of the second liquid from the chamber to the outlet port, with the pressurized second liquid serving to collapse the bag and expel the first liquid contained therein via the second conduit to the first conduit for mixture with the exiting flow of the second liquid. The second conduit lacks flow restrictions, such as metering orifices or the like.

### REFERENCE TO RELATED APPLICATION

This application claims priority from Provisional Patent Application No. 62/157,569 filed May 6, 2015.

### BACKGROUND DISCUSSION

U.S. Pat. No. 7,451,895 discloses a liquid dispensing system comprising a container containing at least one flexible bag. A first liquid is contained in the bag. A manifold chamber is in communication with the bag via a first metering orifice, and with the interior of the container via a second metering orifice. A second liquid is introduced under pressure into the container. The thus introduced second liquid serves to pressurize the first liquid in the bag, with the first and second metering orifices serving to respectively admit metered amounts of the first and second liquids into the manifold chamber for combination into a liquid mixture dispensed through an outlet. The metering orifices constrict flow and are prone to blockage when processing syrups and the like with elevated viscosities and/or high levels of suspended solids.

### FIELD OF THE INVENTION

This invention relates generally to liquid delivery systems, and is concerned in particular with a portable system capable of delivering an on demand high ratio mixture of at least two liquids, with at least one of the liquids having an elevated viscosity and/or a high level of suspended solids.

### SUMMARY OF THE INVENTION

In accordance with one aspect of the present invention, a liquid dispensing system comprises a container enclosing a chamber. A flexible bag in the chamber contains a first liquid. First and second conduits are located in the chamber. The first conduit connects the chamber to an outlet port in the container wall, and the second conduit connects the bag to the first conduit.

A supply source introduces a pressurized second liquid into the chamber. The first conduit serves to direct an exiting flow of the second liquid from the chamber to the outlet port, with the pressurized second liquid serving to collapse the bag and expel the first liquid contained therein via the second conduit to the first conduit for mixture with the exiting flow of the second liquid.

The first liquid may typically comprise a high viscosity beverage concentrate, and the second liquid may comprise municipal tap water.

The supply source of the liquid dispenser system may include a constant flow valve located externally of the container.

The liquid dispenser may further comprise check valves in one or both of the first and second conduits for preventing a reverse flow of liquid into said chamber.

The first conduit may include a metering orifice. However, the second conduit does not include any flow restriction devices such as metering orifices.

The first conduit may communicate with an upper region of the chamber, and the pressurized liquid may be introduced into a lower region of the chamber via an inlet port in the container.

A third open ended bypass conduit may be arranged between the container wall and the bag, and may extend from the lower region to the upper region of the chamber.

A liquid dispensing system in accordance with another aspect of the present invention may comprise a container enclosing a chamber having upper and lower region.

A flexible bag in the chamber extends vertically between the upper and lower regions.

A first liquid is contained in the bag, and first, second and third conduits are arranged in the chamber. The first conduit leads to an outlet port in the container wall. The second conduit connects the bag to the first conduit.

A supply source introduces a pressurized second liquid into the chamber and separately into the third conduit for delivery to the first conduit. The first conduit serves to direct an exiting flow of the second liquid to the outlet port, with the pressurized second liquid in the chamber serving to collapse the bag and expel the first liquid contained therein via the second conduit to the first conduit for mixture with the exiting flow of the second liquid.

The pressurized liquid may be introduced into a T-fitting in the chamber. The T-fitting has one branch communicating with the third conduit and another branch communicating with the chamber.

### BRIEF DESCRIPTION OF THE DRAWINGS

FIG. 1 is a diagrammatic illustration of an exemplary embodiment of a liquid delivery system in accordance with the present invention;

FIGS. 2A and 2B are illustrations depicting a typical check valve useful in the liquid delivery system of the present invention;

FIGS. 3 and 4 are enlarged views of portions of the system depicted in FIG. 1;

FIG. 5 is a diagrammatic illustration of a second exemplary embodiment of a liquid delivery system in accordance with the present invention;

FIG. 6 is a diagrammatic illustration of a third exemplary embodiment of a liquid delivery system in accordance with the present invention; and

FIG. 7 is an enlarged view of the T-shaped fitting shown in FIG. 6.

### DETAILED DESCRIPTION

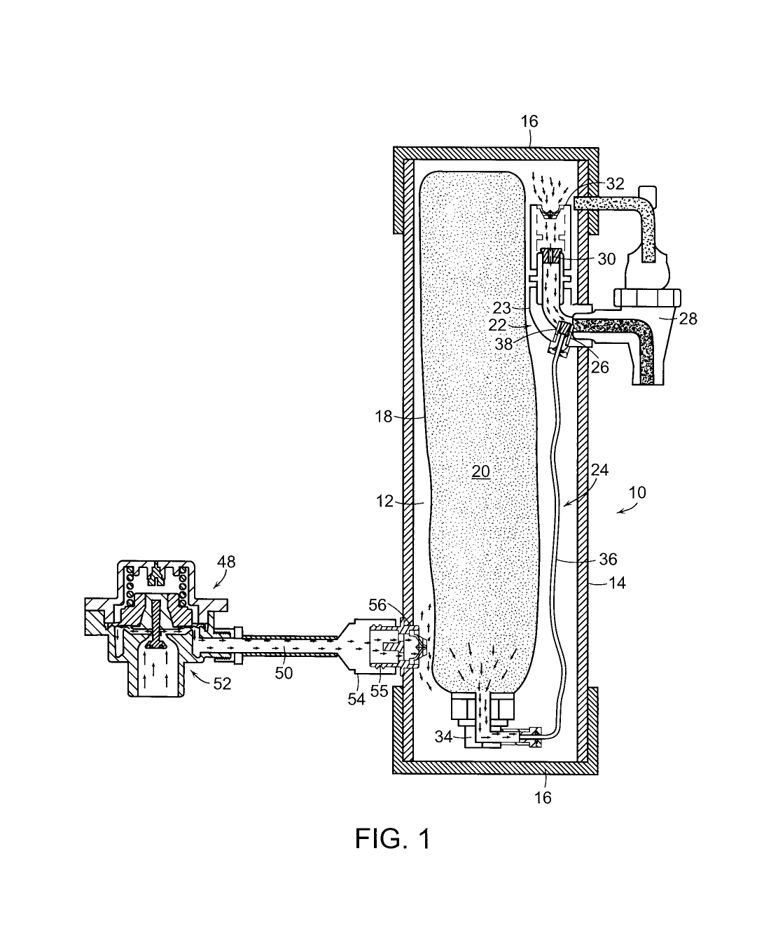

An exemplary embodiment of a liquid delivery system embodying aspects of the present invention is depicted in FIG. 1.

The system comprises a container 10 enclosing a chamber 12. The container may advantageously comprise a tubular wall 14 closed at its opposite ends by caps 16.

At least one flexible and collapsible bag 18 is contained in the chamber 12. The bag 18 typically will contain a first liquid 20, which may comprise a high viscosity beverage concentrate, for example a tea concentrate.

First and second conduits 22, 24 are located in the chamber 12. The first conduit 22 may typically include an elbow fitting 23, one end of which communicates with an outlet port 26 in the container wall 14. The outlet port 26 may lead to an on/off faucet 28 or other like dispenser. The dispenser may be manually operable, as shown, or of any known remotely operable type.

The first conduit 22 may additionally include an orifice 30 fitted to the opposite end of the elbow fitting 23, and a check valve 32. It will thus be seen that the first conduit 22, which as shown includes the elbow fitting 23, orifice 30 and check valve 32, provides a connection between the chamber 12 and the outlet port 26, which in turn communicates with the dispensing faucet 28.

The second conduit 24 may include an L-shaped fitting 34 closing the bottom open end of the bag 18, and a flexible tube 36 communicating at its opposite ends with the fitting 34 and the interior of the elbow fitting 23.

A check valve 38 may be included in the tube 36. The second conduit 24, which includes the fitting 34, tube 36 and check valve 38 thus connects the bag 18 to the first conduit 22, with such connection being achieved entirely within the confines of chamber 12.

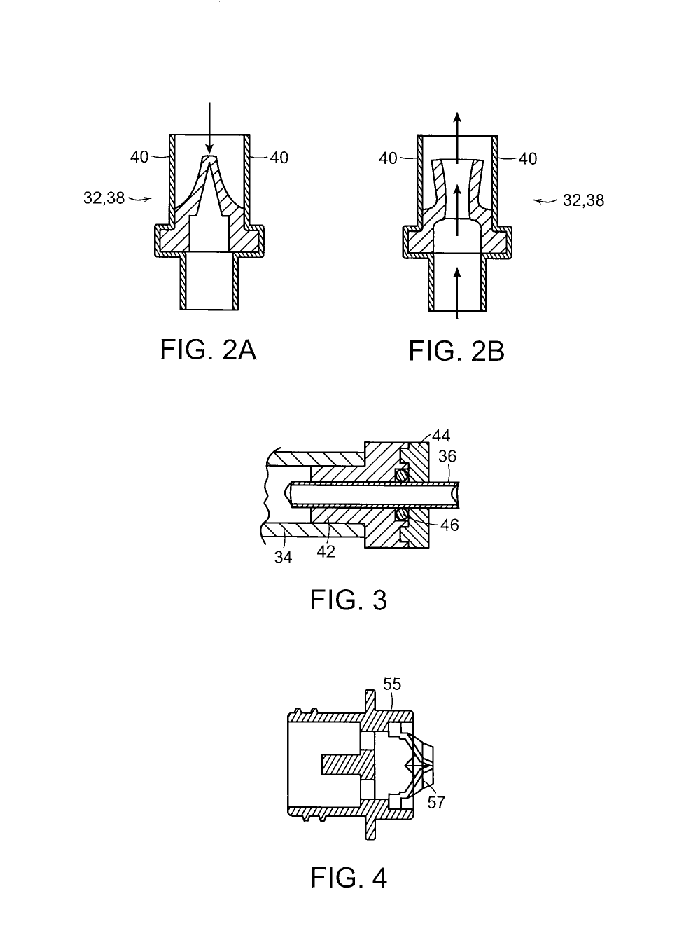

At least one and advantageously both of the check valves 32, 38 may comprise so called “duckbill valves”, an exemplary embodiment of which is depicted in FIGS. 2A and 2B. Duckbill valves comprise one-piece elastomeric components that act as backflow prevention devices. They include elastomeric lips 40 in the shape of a duckbill which as shown in FIG. 2A, are closed by a backflow, and as shown in FIG. 2B, are opened by a forward flow. Although not shown, it is to be understood that other known check valves may be substituted for the disclosed duckbill valves.

With reference to FIG. 3, it will be seen that the lower end of the flexible tube 36 is sealingly connected to the fitting 34 by means of an insert 42 coacting with cap 44 to compress an O-ring 46 around the tube. A similar arrangement may sealingly connect the upper end of the tube 36 to the elbow fitting 23.

The flexible tube 36 provides a smooth continuous connection between the fittings 34 and 23, without any internal restrictions of the type provided by metering orifices or the like.

A supply source 48 serves to introduce a pressurized second liquid 50 into the chamber 16. The second liquid may typically comprise tap water drawn from a municipal supply system.

Advantageously, the supply source 48 may include a constant flow valve 52 connected by means of a dry breakquick connect coupling 54 to a nipple 55 projecting from an inlet port 56 in the container wall 14. As can best be seen in FIG. 4, the nipple 55 may be provided with a duckbill check valve 57.

As herein employed, the term “constant flow valve” means a flow control valve of the type described, for example, in any one of U.S. Pat. Nos. 7,617,839; 6,026,850 or 6,209,578, the descriptions of which are herein incorporated by reference in their entirety. These types of valves are normally closed, are opened in response to pressures exceeding a lower threshold level, are operative at pressures between the lower threshold level and an upper threshold level to deliver liquids at a substantially constant pressures, and are again closed at pressures above the upper threshold level.

When the faucet 28 is opened, the first conduit 22 serves to direct an exiting flow of the pressurized second liquid 50 (water) from the chamber 12 through the outlet port 26. The pressurized second liquid in the chamber 12 also serves to collapse the bag 18, causing the first liquid 20 (beverage concentrate) to be expelled via the second conduit 24 for injection into the exiting flow of the second liquid in the elbow fitting 23 of the first conduit 22. Injection of the first liquid into the exiting flow of the second liquid resists layering of the first liquid and thereby promotes mixture of both liquids.

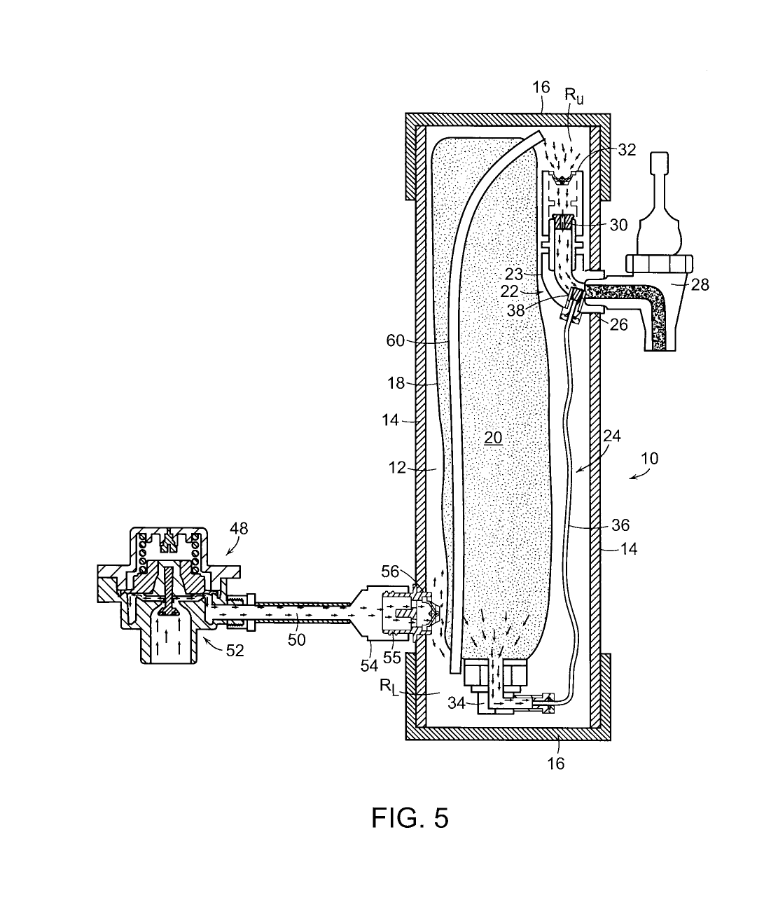

In accordance with a second aspect of the present invention, and as depicted in FIG. 5, a third open ended bypass conduit. 60 is arranged between the interior of container wall 14 and the bag 18. Conduit 60 extends between upper and lower regions R_{U}, R_{L} of the chamber 12. In the event that during usage of the system, the bag 18 should collapse against the container wall 14, the tube will continue to ensure delivery of the second liquid to the upper chamber R_{U}.

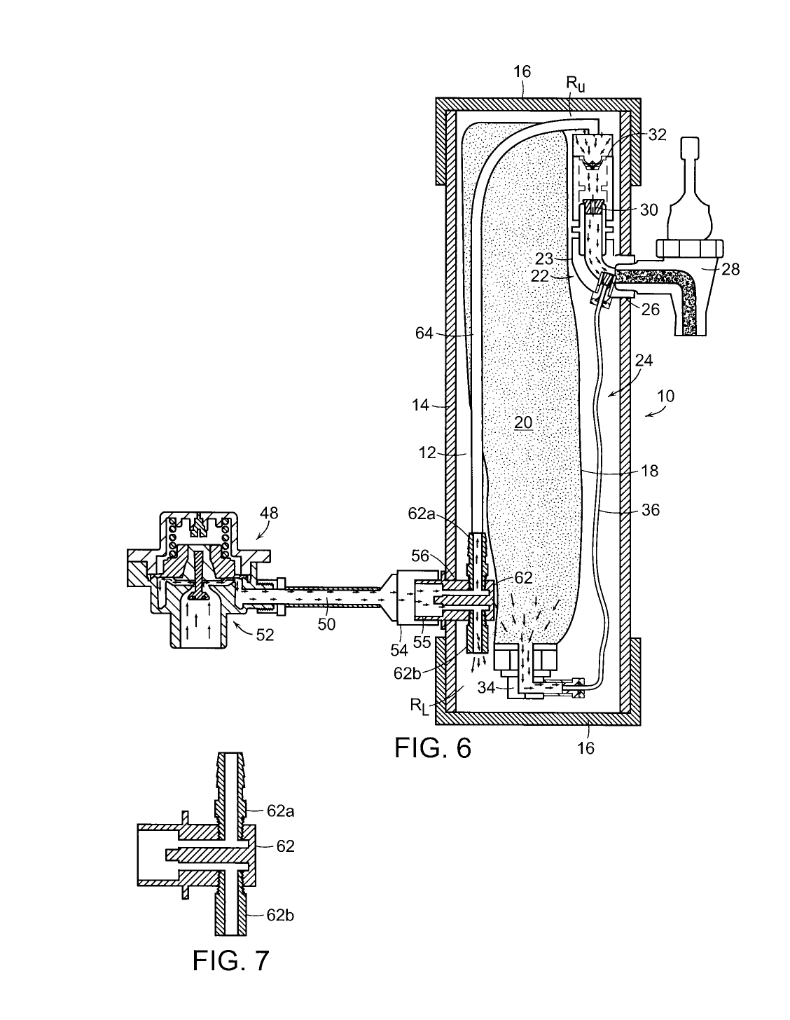

In accordance with a third aspect of the present invention, as depicted in FIGS. 6 and 7, the second pressurized liquid 50 is introduced into a T-shaped fitting 62 located in the lower region R_{L} of chamber 12. Fitting 62 has one branch 62a communicating with the lower end of a third conduit 64 and another branch 62b communicating with the lower region R_{L} of chamber 12. The upper end of conduit 64 is connected directly to the first conduit 22 in the upper region R_{U} of the chamber 12.

With this arrangement, the second liquid 50 is delivered to conduit 60 separately from that being delivered to the chamber 12.

What is claimed is:

1. A liquid dispensing system comprising:
a container enclosing a chamber;
a flexible bag in said chamber;
a first liquid contained in said bag;
first and second conduits in said chamber, said first conduit connecting said chamber to an outlet port in said container, said second conduit connecting said bag to said first conduit; and
supply means for introducing a pressurized second liquid into said chamber, said first conduit serving to direct an exiting flow of said second liquid from said chamber to said outlet port, with said pressurized second liquid serving to collapse said bag and expel the first liquid contained therein via said second conduit to said first conduit for mixture with the exiting flow of said second liquid.

2. The liquid dispensing system of claim 1 wherein said supply means includes a constant flow valve located externally of said container.

3. The liquid dispensing system of claim 1 further comprising a check valve in said first conduit for preventing a reverse flow of liquid into said chamber.

4. The liquid dispensing system of claim I further comprising a check valve on said second conduit for preventing a reverse flow of liquid into said bag.

5. The liquid dispensing system of claim 1 wherein said first conduit includes a metering orifice.

6. The liquid dispensing system of claim 1 wherein said second conduit comprises a flexible tube.

7. The liquid dispensing system of claim 3 or 4 wherein said check valves comprise duckbill valves

8. The liquid delivery system of claim 1 wherein said supply means is connected to said container by a dry breakquick connect coupling.

9. The liquid dispensing system of claim 1 wherein said first conduit communicates with an upper region of said chamber, and wherein said pressurized liquid is introduced into a lower region of said chamber via an inlet port in said container.

10. The liquid dispenses of claim 9 further comprising a third open ended bypass conduit arranged between the interior of said container and said bag, said bypass conduit extending from the lower region to the upper region of said chamber.

11. A liquid dispensing system comprising:
a container enclosing a chamber having upper and lower regions;
a flexible bag in said chamber, said bag extending vertically between said upper and lower regions;
a first liquid contained in said bag;
first, second and third conduits in said chamber, said first conduit leading to an outlet port in said container, said second conduit connecting said bag to said first conduit; and
supply source for introducing a pressurized second liquid into said chamber and separately into said third conduit for delivery to said first conduit, said first conduit serving to direct an exiting flow of said second liquid to said outlet port, with said pressurized second liquid in said chamber serving to collapse said bag and expel the first liquid contained therein via said second conduit to said first conduit for mixture with the exiting flow of said second liquid.

12. The liquid dispensing system of claim 11 wherein said supply source includes a constant flow valve located externally of said container.

13. The liquid dispensing system of claim 11 further comprising a check valve in said first conduit for preventing a reverse flow of liquid into said chamber.

14. The liquid dispensing system of claim 11 further comprising a check valve on said second conduit for preventing a reverse flow of liquid into said bag.

15. The liquid dispensing system of claim 11 wherein said first conduit includes a metering orifice.

16. The liquid dispending system of claim 11 wherein said pressurized liquid is introduced into a T-fitting in said chamber, said T-fitting having one branch communicating with said third conduit and having another branch communicating with said chamber.
